(19) United States
(12) Patent Application Publication
(10) Pub. No.: US 2023/0269856 A1
(43) Pub. Date: Aug. 24, 2023

(54) DIMMER SWITCH CONFIGURED TO BE CONTROLLED BY REMOTE CONTROLLER

(71) Applicant: Xiamen Tenia Lighting & Electrical Co., Ltd, Xiamen (CN)

(72) Inventors: Fudi SU, Xiamen (CN); Zhijian YE, Xiamen (CN); Mingxuan LI, Xiamen (CN)

(21) Appl. No.: 18/105,905

(22) Filed: Feb. 6, 2023

(30) Foreign Application Priority Data
Feb. 18, 2022 (CN) 202220338187.6

(51) Int. Cl. H05B 47/19; H01H 9/02

(52) U.S. Cl. CPC H05B 47/19; H01H 9/02

(57) ABSTRACT

A dimmer switch configured to be controlled by a remote controller is provided. The dimmer switch comprises a supporting portion for supporting the remote controller, and the remote controller is selectively matched in the supporting portion. A first surface of the supporting portion that is configured to be in contact with the remote controller is disposed with a first electric connection member configured to be in data communication with the remote controller, and a second surface of the remote controller that is configured to be in contact with the first surface of the dimmer switch is disposed with a second electric connection member configured to be in data communication with the dimmer switch. When the remote controller is matched with the supporting portion of the dimmer switch, the first electric connection member of the dimmer switch is in contact with the second electric connection member of the remote controller.

### RELATED APPLICATIONS

This application claims priority to Chinese patent application number 202220338187.6, filed on Feb. 18, 2022. Chinese patent application number 202220338187.6 is incorporated herein by reference.

### FIELD OF THE DISCLOSURE

The present disclosure relates to the technical field of electrical equipment, and in particular to a dimmer switch controlled through a remote controller.

### BACKGROUND OF THE DISCLOSURE

A dimmer switch is an electric device for changing a luminous flux of a light source in a lighting device and adjusting an illumination level. A basic principle of the dimmer switch is to change an effective value of a current input to the light source so as to achieve an aim of dimming. The dimmer switch in the existing techniques achieves dimming control through a remote controller. The dimmer switch is usually equipped with the remote controller, and the remote controller is operated to achieve the dimming operation. When using the dimmer switch with the remote controller, the remote controller needs to be paired with the dimmer switch. Since the remote controller is in wireless communication with the dimmer switch, a setting button needs to be pressed to enter a pairing mode to pair the dimmer switch and the remote controller. Therefore, the operations are very cumbersome, the user experience is greatly influenced.

### BRIEF SUMMARY OF THE DISCLOSURE

The present disclosure provides a dimmer switch configured to be controlled by a remote controller. Through institutional advancement, the dimmer switch greatly makes things convenient for a user to pair the remote controller and the dimmer switch quickly at any time.

In order to solve the technical problem, a dimmer switch configured to be controlled by a remote controller is provided. The dimmer switch comprises a supporting portion for supporting the remote controller, and the remote controller is selectively matched in the supporting portion of the dimmer switch. A first surface of the supporting portion of the dimmer switch that is configured to be in contact with the remote controller is disposed with a first electric connection member configured to be in data communication with the remote controller, and a second surface of the remote controller that is configured to be in contact with the first surface of the supporting portion of the dimmer switch is disposed with a second electric connection member configured to be in data communication with the dimmer switch. When the remote controller is matched with the supporting portion of the dimmer switch, the first electric connection member of the dimmer switch is in contact with the second electric connection member of the remote controller.

The first surface of the supporting portion of the dimmer switch is disposed with a third electric connection member configured to provide a power supply signal to the remote controller, and the second surface of the remote controller is disposed with a fourth electric connection member configured to receive the power supply signal provided by the dimmer switch. When the remote controller is matched with the supporting portion of the dimmer switch, the third electric connection member of the dimmer switch is in contact with the fourth electric connection member of the remote controller.

The supporting portion of the dimmer switch is a groove recessed rearward on a front portion of the dimmer switch. The first surface of the supporting portion of the dimmer switch is a bottom surface of the groove, and the second surface of the remote controller is a back surface of the remote controller.

The first electric connection member comprises at least one first electric connection piece, and the third electric connection member comprises two third electric connection pieces. The second electric connection member comprises at least one second electric connection piece, and the fourth electric connection member comprises two fourth electric connection pieces.

The at least one first electric connection piece of the first electric connection member is matched with the at least one second electric connection piece of the second electric connection member in a contact manner, and the two third electric connection pieces of the third electric connection member is matched with the two fourth electric connection pieces of the fourth electric connection member in a contact manner.

The at least one first electric connection piece of the first electric connection member and the two third electric connection pieces of the third electric connection member are pins, and the at least one second electric connection piece of the second electric connection member and the two fourth electric connection pieces of the fourth electric connection member are insertion grooves configured to be matched with the pins respectively.

The dimmer switch comprises a first microcontroller unit (MCU) chip and a first wireless module. Each of the first electric connection member and the third electric connection member are connected to the first MCU chip, and the first MCU chip is connected to the first wireless module.

The remote controller comprises a second microcontroller unit (MCU) chip, a second wireless module, a power management module, and a battery. The second electric connection member is connected to the second MCU chip, and the fourth electric connection member is connected to the power management module. The power management module is connected to the battery, and the second MCU chip is connected to each of the second wireless module, the power management module, and the battery.

Compared with the existing techniques, the technical solution has the following advantages.

1. The present disclosure provides a dimmer switch controlled by the remote controller. The first surface of the supporting portion of the dimmer switch for being in contact with the remote controller is disposed with the first electric connection member for being in data communication with the remote controller. The second surface of the remote controller for being in contact with the first surface of the dimmer switch is disposed with the second electric connection member for being in data communication with the dimmer switch. When the remote controller is matched with the supporting portion of the dimmer switch, the first electric connection member of the dimmer switch is in contact with the second electric connection member of the remote controller. The present disclosure provides this kind of structure to enable the remote controller to be rapidly paired with the dimmer switch in a contact manner, which is greatly convenient for a user to rapidly pair the remote controller and dimmer switch at any time.

2. The present disclosure provides a dimmer switch controlled by the remote controller. The first surface of the supporting portion of the dimmer switch is further disposed with the third electric connection member for providing the power supply signal for the remote controller. The second surface of the remote controller is disposed with the fourth electric connection member for receiving the power supply signal provided by the dimmer switch. When the remote controller is matched with the supporting portion of the dimmer switch, the third electric connection member of the dimmer switch is in contact with the fourth electric connection member of the remote controller. The present disclosure provides this kind of structure to enable the battery of remote controller to be charged using the third electric connection member of the dimmer switch that is matched with the fourth electric connection member of remote controller.

The present disclosure will be further described below in combination with the accompanying drawings and embodiments. However, the present disclosure is not limited to the following embodiment, and the dimmer switch controlled by the remote controller is not limited to the following embodiment.

### BRIEF DESCRIPTION OF THE DRAWINGS

FIG. 1 illustrates a perspective view of a dimmer switch and a remote controller according to an embodiment of the present disclosure.

FIG. 2 illustrates a perspective view of a remote controller according to an embodiment of the present disclosure when a back surface of the remote controller faces frontward.

FIG. 3 illustrates a schematic block circuit diagram of an embodiment of the present disclosure.

### DETAILED DESCRIPTION OF THE EMBODIMENTS

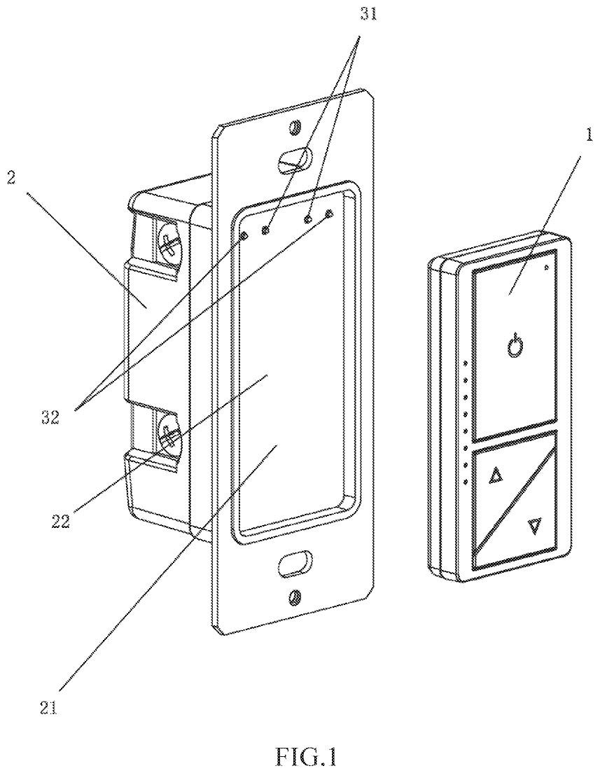

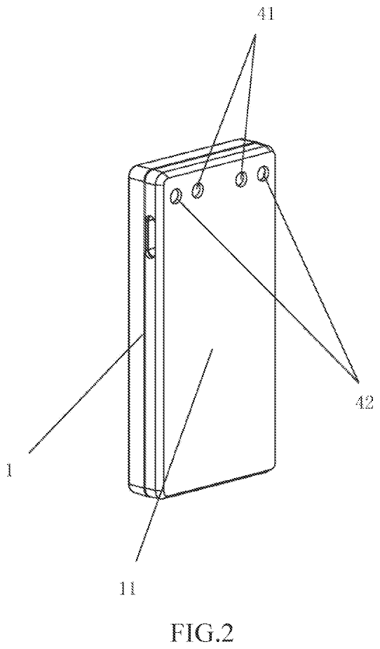

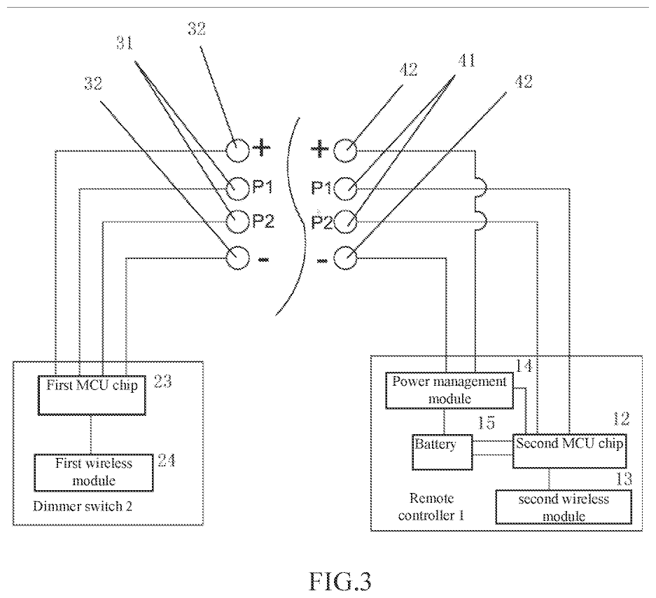

Referring to FIGS. 1 to 3, a dimmer switch 2 configured to be controlled by a remote controller 1 in the present disclosure is provided. The dimmer switch 2 comprises a supporting portion 21 for supporting the remote controller, and the remote controller 1 is selectively matched in the supporting portion 21 of the dimmer switch 2. A first surface 22 of the supporting portion 21 of the dimmer switch 2 that is configured to be in contact with the remote controller 1 is disposed with a first electric connection member 31 configured to be in data communication with the remote controller 1. A second surface 11 of the remote controller 1 that is configured to be in contact with the first surface 22 is disposed with a second electric connection member 41 configured to be in data communication with the dimmer switch 2. When the remote controller 1 is matched with the supporting portion 21 of the dimmer switch 2, the first electric connection member 31 of the dimmer switch 2 is in contact with the second electric connection member 41 of the remote controller 1.

In this embodiment, the first surface 22 of the supporting portion 21 of the dimmer switch 2 is disposed with a third electric connection member 32 configured to provide a power supply signal to the remote controller 1. The second surface 11 of the remote controller 1 that is configured to be in contact with the first surface 22 of the dimmer switch 2 is disposed with a fourth electric connection member 42 configured to receive the power supply signal provided by the dimmer switch 2. When the remote controller 1 is fitted to the supporting portion 21 of the dimmer switch 2, the third electric connection member 32 of the dimmer switch 2 is in contact with the fourth electric connection member 42 of the remote controller 1.

In the present embodiment, the supporting portion 21 of the dimmer switch 2 is a groove recessed rearward on a front portion of the dimmer switch 2, and the first surface 22 of the dimmer switch 2 is a bottom surface of the groove. The second surface 11 of the remote controller 1 that is configured to be in contact with the first surface 22 of the dimmer switch 2 is a back surface of the remote controller 1.

In the present embodiment, the first electric connection member 31 comprises two first electric connection pieces, and the third electric connection member 32 comprises two third electric connection pieces. The second electric connection member 41 comprises two second electric connection pieces, and the fourth electric connection member 42 comprises two fourth electric connection pieces. The first electric connection member 31 and the second electric connection member 41 of the present embodiment respectively comprises the two first electric connection pieces and the two second electric connection pieces, but of course, the first electric connection member 31 and the second electric connection member 41 may respectively comprise one or three first electric connection pieces and one or three second electric connection pieces, and the like.

In this embodiment, the two first electric connection pieces of the first electric connection member 31 and the two third electric connection pieces of the third electric connection member 32 are pins. The two second electric connection pieces of the second electric connection member 41 and the two fourth electric connection pieces of the fourth electric connection member 42 are insertion grooves capable of being matched with the pins respectively.

In this embodiment, the dimmer switch 2 comprises a first microcontroller unit (MCU) chip 23 and a first wireless module 24. Each of the first electric connection member 31 and the third electric connection member 32 are connected to the first MCU chip 23, and the first MCU chip 23 is connected to the first wireless module 24.

In this embodiment, the remote controller 1 comprises a second MCU chip 12, a second wireless module 13, a power management module 14, and a battery 15. The second electric connection member 41 is connected to the second MCU chip 12, the fourth electric connection member 42 is connected to the power management module 14, and the power management module 14 is connected to the battery 15. The second MCU chip 12 is connected to each of the second wireless module 13, the power management module 14, and the battery 15.

The present disclosure provides a dimmer switch 2 controlled by the remote controller 1. The first surface 22 of the supporting portion 21 of the dimmer switch 2 for being in contact with the remote controller 1 is disposed with the first electric connection member 31 for being in data communication with the remote controller 1. The second surface 11 of the remote controller 1 for being in contact with the first surface 22 of the dimmer switch 2 is disposed with the second electric connection member 41 for being in data communication with the dimmer switch 2. When the remote controller 1 is matched with the supporting portion 21 of the dimmer switch 2, the first electric connection member 31 of the dimmer switch 2 is in contact with the second electric connection member 41 of the remote controller 1. The present disclosure provides this kind of structure to enable the remote controller 1 to be rapidly paired with the dimmer switch 2 in a contact manner, which is greatly convenient for a user to rapidly pair the remote controller 1 and dimmer switch 2 at any time. The software of the pairing process is implemented using software of conventional technology.

The present disclosure provides a dimmer switch 2 controlled by the remote controller 1. The first surface 22 of the supporting portion 21 of the dimmer switch 2 is further disposed with the third electric connection member 32 for providing the power supply signal for the remote controller 1. The second surface 11 of the remote controller 1 for being in contact with the dimmer switch 2 is disposed with the fourth electric connection member 42 for receiving the power supply signal provided by the dimmer switch 2. When the remote controller 1 is matched with the supporting portion 21 of the dimmer switch 2, the third electric connection member 32 of the dimmer switch 2 is in contact with the fourth electric connection member 42 of the remote controller 1. The present disclosure provides this kind of structure to enable the battery 15 of remote controller to be charged using the third electric connection member 32 of the dimmer switch 2 that is matched with the fourth electric connection member 42 of remote controller 1.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A dimmer switch configured to be controlled by a remote controller, wherein:
the dimmer switch comprises a supporting portion for supporting the remote controller,
the remote controller is selectively matched in the supporting portion of the dimmer switch,
a first surface of the supporting portion of the dimmer switch that is configured to be in contact with the remote controller is disposed with a first electric connection member configured to be in data communication with the remote controller,
a second surface of the remote controller that is configured to be in contact with the first surface of the supporting portion of the dimmer switch is disposed with a second electric connection member configured to be in data communication with the dimmer switch, and
when the remote controller is matched with the supporting portion of the dimmer switch, the first electric connection member of the dimmer switch is in contact with the second electric connection member of the remote controller.

2. The dimmer switch configured to be controlled by the remote controller according to claim 1, wherein:
the first surface of the supporting portion of the dimmer switch is disposed with a third electric connection member configured to provide a power supply signal to the remote controller,
the second surface of the remote controller is disposed with a fourth electric connection member configured to receive the power supply signal provided by the dimmer switch, and
when the remote controller is matched with the supporting portion of the dimmer switch, the third electric connection member of the dimmer switch is in contact with the fourth electric connection member of the remote controller.

3. The dimmer switch configured to be controlled by the remote controller according to claim 1, wherein:
the supporting portion of the dimmer switch is a groove recessed rearward on a front portion of the dimmer switch,
the first surface of the supporting portion of the dimmer switch is a bottom surface of the groove, and
the second surface of the remote controller is a back surface of the remote controller.

4. The dimmer switch configured to be controlled by the remote controller according to claim 2, wherein:
the first electric connection member comprises at least one first electric connection piece,
the third electric connection member comprises two third electric connection pieces,
the second electric connection member comprises at least one second electric connection piece, and
the fourth electric connection member comprises two fourth electric connection pieces.

5. The dimmer switch configured to be controlled by the remote controller according to claim 4, wherein:
the at least one first electric connection piece of the first electric connection member is matched with the at least one second electric connection piece of the second electric connection member in a contact manner, and
the two third electric connection pieces of the third electric connection member is matched with the two fourth electric connection pieces of the fourth electric connection member in a contact manner.

6. The dimmer switch configured to be controlled by the remote controller according to claim 4, wherein:
the at least one first electric connection piece of the first electric connection member and the two third electric connection pieces of the third electric connection member are pins, and
the at least one second electric connection piece of the second electric connection member and the two fourth electric connection pieces of the fourth electric connection member are insertion grooves configured to be matched with the pins respectively.

7. The dimmer switch configured to be controlled by the remote controller according to claim 2, wherein:
the dimmer switch comprises a first microcontroller unit (MCU) chip and a first wireless module,
each of the first electric connection member and the third electric connection member are connected to the first MCU chip, and
the first MCU chip is connected to the first wireless module.

8. The dimmer switch configured to be controlled by the remote controller according to claim 2, wherein:
the remote controller comprises a second microcontroller unit (MCU) chip, a second wireless module, a power management module, and a battery,
the second electric connection member is connected to the second MCU chip,
the fourth electric connection member is connected to the power management module,
the power management module is connected to the battery, and
the second MCU chip is connected to each of the second wireless module, the power management module, and the battery.
